(19) United States
(12) Patent Application Publication
(10) Pub. No.: US 2025/0070230 A1
(43) Pub. Date: Feb. 27, 2025

(54) SULFIDE SOLID ELECTROLYTE, AND PREPARATION METHOD AND USE THEREOF

(71) Applicant: Shanghai Firm-Lithium New Energy Technology Co., Ltd., Shanghai (CN)

(72) Inventors: Xi ZHANG, Shanghai (CN); Jinhui ZHU, Shanghai (CN); Zhenying CHEN, Shanghai (CN)

(21) Appl. No.: 18/293,895

(22) PCT Filed: May 12, 2023
(86) PCT No.: PCT/CN2023/093799

§ 371 Date: Jan. 31, 2024

(30) Foreign Application Priority Data
May 13, 2022 (CN) 202210519948.2

(51) Int. Cl. H01M 10/0562; C01B 25/08

(52) U.S. Cl. CPC H01M 10/0562; C01B 25/088; C01P 2006/40; H01M 2300/008

(57) ABSTRACT

Provided are a sulfide solid electrolyte, and a preparation method and use thereof. The sulfide solid electrolyte has a chemical composition formula of Li₆P₁₋ₐ(M)ₐS₅X (where M is one or more selected from the group consisting of V, Nb, and Ta, and X is one or more selected from the group consisting of F, Cl, and Br). The preparation method includes: weighing raw materials of a Li source, a P source, an S source, an M source, and an X source, and mixing to be uniform to obtain a mixture, and subjecting the mixture to ball milling to obtain a precursor powder of the sulfide solid electrolyte; sieving the precursor powder to obtain a sieved powder, and then pressing the sieved powder into a solid sheet; and subjecting the solid sheet to vacuum high-temperature sintering to obtain the sulfide solid electrolyte.

### CROSS-REFERENCE TO RELATED APPLICATIONS

This application is the U.S. national stage application of International Patent Application No. PCT/CN2023/093799, filed May 12, 2023, which claims the benefit under 35 U.S.C. § 119 of Chinese Patent Application No. CN202210519948.2 entitled “SULFIDE SOLID ELECTROLYTE, AND PREPARATION METHOD AND USE THEREOF”, filed with the China National Intellectual Property Administration (CNIPA) on May 13, 2022, the disclosures of each of which are incorporated herein by reference in their entirety as part of the present application.

### TECHNICAL FIELD

The present disclosure belongs to the field of energy technology, and specifically relates to a sulfide solid electrolyte, and a preparation method and use thereof. In particular, the present disclosure relates to a method for preparing a sulfide solid electrolyte doped with a VB group element and a halogen, and use of the sulfide solid electrolyte in a full cell.

### BACKGROUND

Lithium-ion batteries have been widely used in portable electronics and are attracting increasing attention in applications such as energy storage systems and electric vehicles. All-solid-state batteries based on solid electrolytes are candidates for developing next-generation batteries with high energy density and safety. In addition, solid electrolytes significantly improve safety by replacing the flammable and volatile liquid electrolytes in traditional lithium-ion batteries. Among various types of solid electrolytes, sulfide solid electrolytes have been widely studied due to their high ionic conductivity. Due to desirable mechanical properties, the sulfide solid electrolytes also offer great advantages in processing.

Recently, lithium argyrodites (LPSC)-type sulfide solid electrolytes have been considered as one of the promising sulfide electrolytes due to high ionic conductivity and relatively low cost. However, the LPSC-type sulfide solid electrolytes show many problems such as poor compatibility with Li metal anode and poor cycle stability. These problems have become a major challenge for the future practical application of LPSC-type sulfide solid electrolytes.

### SUMMARY

To overcome the shortcomings of the existing technology, the present disclosure aims to provide a sulfide solid electrolyte, and a preparation method and use thereof. In the present disclosure, the sulfide solid electrolyte doped with a VB group element and a halogen has a chemical composition formula of Li₆P₁₋ₐ(M)ₐS₅X (where M is one or more selected from the group consisting of V, Nb, and Ta, and X is one or more selected from the group consisting of F, Cl, and Br). In the sulfide solid electrolyte according to the present disclosure, P element is partially replaced by an element from a VB group, such that controllable doping of the V, Nb, Ta and other elements improves a compatibility with a series of lithium anodes while ensuring that the sulfide solid electrolyte has a desirable argyrodite crystal phase. The sulfide solid electrolyte exhibits a better electrochemical stability, thereby improving the cycle stability of a sulfide all-solid-state battery.

To achieve the above object, the present disclosure provides the following technical solutions.

The present disclosure provides a sulfide solid electrolyte, where the sulfide solid electrolyte has a chemical composition formula of Li₆P₁₋ₐ(M)ₐS₅X; where M is one or more selected from the group consisting of V, Nb, and Ta, and X is one or more selected from the group consisting of F, Cl, and Br.

Compared with other metal elements, doping of the M element from a VB group could generate a layer of M₂O₅ on a surface of the sulfide electrolyte, thereby improving a cycle stability of the electrolyte and showing a desirable compatibility with the lithium anode.

In some embodiments, a is in a range of greater than 0 and less than 1.

The present disclosure further provides a method for preparing the sulfide solid electrolyte as described in the above solutions, including (or consisting of) the following steps:
S1, weighing raw materials of a Li source, a P source, an S source, an M source, and an X source according to a stoichiometric ratio of the Li₆P₁₋ₐ(M)ₐS₅X, and then mixing to be uniform to obtain a mixture, and subjecting the mixture to ball milling to obtain a precursor powder of the sulfide solid electrolyte;
S2, sieving the precursor powder to obtain a sieved powder, and then pressing the sieved powder into a solid sheet; and
S3, subjecting the solid sheet to vacuum high-temperature sintering to obtain the sulfide solid electrolyte.

In some embodiments, the raw materials in step S1 include (or consist of) the following components:
the Li source, being one or more selected from the group consisting of LiH, Li₂S₂, and Li₂S;
the S source, being one or more selected from the group consisting of S, H₂S, P₂S₅, P₄S₉, P₄S₃, Li₂S₂, and Li₂S;
the P source, being one or more selected from the group consisting of P, P₂S₅, P₄S₉, P₄S₃, P₄S₆, and P₄S₅;
the X source, being one or more selected from the group consisting of LiCl, LiBr, LiI, LiF, VCl₅, NbCl₅, and TaCl₅; and
the M source, being one or more selected from the group consisting of VF₅, NbCl₅, and TaCl₅.

In an embodiment, the ball milling in step S1 is conducted at a speed of 380 rpm to 1,500 rpm for 7 h to 48 h. Before the ball milling, manual grinding is conducted for 15 min to 30 min, followed by the ball milling mechanically. The ball milling mechanically is conducted by using a planetary ball mill.

In some embodiments, the pressing in step S2 is conducted at a pressure of 300 MPa to 500 MPa. Excessive pressure may easily damage the mold; and insufficient pressure may easily lead to insufficient compaction, resulting in the inability to form effective crystal phases during the sintering.

In some embodiments, the solid sheet in step S2 has a thickness of 200 μm to 1,000 μm. Excessive thickness could easily lead to difficulty in demolding and insufficient sintering during the sintering; and insufficient thickness could easily cause the electrolyte sheet to break.

In some embodiments, sieving the precursor powder in step S2 is conducted by using a sieve of 300 mesh to 1,200 mesh.

In some embodiments, the method further includes conducting grinding before the sieving. In an embodiment, the grinding is conducted by using an agate mortar.

In some embodiments, step S3 is performed by sealing the solid sheet in a vacuum quartz tube, and then placing into a muffle furnace, and conducting high-temperature sintering to obtain the sulfide solid electrolyte.

In some embodiments, the high-temperature sintering in step S3 is conducted at a temperature of 350° C. to 700° C. for 1 h to 8 h at a heating rate of 0.5° C./min to 5° C./min. Excessive or insufficient temperature may affect the formation of an effective crystal phase of the target electrolyte; while excessive or insufficient heating rate may also affect the formation of the crystal phase.

In some embodiments, cooling to room temperature is conducted at a rate of 0.5° C./min to 5° C./min after the high-temperature sintering is completed.

In some embodiments, the weighing, the mixing to be uniform, the ball milling, the sieving, the pressing, and the high-temperature sintering in steps S1 to S3 each are conducted under the protection of an inert atmosphere.

The present disclosure further provides use of the sulfide solid electrolyte as described in the above solutions or the sulfide solid electrolyte prepared by the method as described in the above solutions in preparation of a full cell.

The present disclosure further provides a solid-state battery, including (or consisting of) a cathode part, an anode part, and an electrolyte part; where at least one of the cathode part, the anode part, and the electrolyte part includes the sulfide solid electrolyte as described in the above solutions.

In some embodiments, a weight of the sulfide solid electrolyte in the cathode part accounts for 0 wt % to 40 wt % of a total weight of the cathode part. In some embodiments, a cathode active material in the cathode part is one or a mixture of two or more selected from the group consisting of LiCoO₂, LiFePO₄, LiNiₓCo_{y}Mn_{1-x-y}O₂, LiNiₓCo_{y}Al_{1-x-y}O₂, LiNi_{0.5}Mn_{1.5}O₄, and LiFeₓMn₁₋ₓPO₄.

In some embodiments, the anode part is constructed by mixing an anode active material and the sulfide solid electrolyte, and the anode active material is a lithium alloy anode material.

In the present disclosure, a sulfide electrolyte is obtained by introducing a halogen and a VB group element into a sulfide solid electrolyte. The method for preparing the electrolyte has a simple process. The electrolyte has an ionic conductivity reaching the same level as or even better than that of electrolytes in the same field. The cycle stability and electrolyte sheet ductility of the battery during operation are improved by doping with halogen elements and introducing VB group elements. In summary, the present disclosure makes it possible to prepare a sulfide solid electrolyte doped with a small amount of halogen elements and VB group elements, which has a desirable room-temperature ion conductivity, a cycle stability, and a desirable processability.

Compared with the prior art, some embodiments of the present disclosure have the following beneficial effects.
1) The air stability and cycle stability of the target sulfide solid electrolyte are improved by doping with VB group elements.
2) The sulfide solid electrolyte has a further improved cycle stability in all-solid-state batteries after doping with the halogen.
3) The introduction of the sulfide solid electrolyte when preparing a cathode improves an overall electrochemical performance of the battery.

### BRIEF DESCRIPTION OF THE DRAWINGS

FIG. 1 shows cycle efficiency of solid electrolytes prepared in Example 1, Example 2, and Comparative Example 1.

FIG. 2 shows impedance of solid electrolytes prepared in Example 1 and Comparative Example 1.

### DETAILED DESCRIPTION OF THE EMBODIMENTS

The present disclosure will be described in detail below in conjunction with the drawings and examples. The following examples are implemented on the premise of the technical solution of the present disclosure, and provide detailed implementation modes and specific operating processes, which will help those skilled in the art to further understand the present disclosure. It should be pointed out that the scope of the present disclosure is not limited to the following examples. Those modifications and improvements made based on the concept of the present disclosure shall all belong to the scope of the present disclosure.

### EXAMPLE 1

This example provided a Li₆P_{0.8}V_{0.2}S₅F solid electrolyte, which was prepared as follows:

The reagents Li₂S, P₂S₅, and VF₅ were weighed at a stoichiometric ratio of Li₂S:P₂S₅:VF₅=3:0.4:0.2, then mixed and manually ground for 15 min to obtain a mixture. The mixture was put into a zirconia ball mill jar, and zirconia balls were added thereto at a mass ratio of 1:50. After that, the mixture was subjected to ball milling at a speed of 550 rpm for 17 h; a resulting milled sample attached to the wall of the zirconia ball mill jar was scraped off, then ground manually with a mortar for 15 min, and then sieved through a 400-mesh sieve to obtain a uniformly mixed precursor. The precursor was pressed into a solid sheet (with a diameter of 12 mm) at 350 MPa. The solid sheet was packed into a quartz tube and sealed. The solid sheet was heated to a temperature of 550° C. at a heating rate of 0.5° C./min and held at the temperature for 7 h, and then cooled to obtain the Li₆P_{0.8}V_{0.2}S₅F solid electrolyte powder. It can be found from an X-ray diffraction (XRD) that the solid electrolyte powder prepared by this method is in an argyrodite-type cubic phase with desirable crystal form and high purity. The solid electrolyte powder was pressed at a pressure of 580 MPa for 3 min to obtain a solid electrolyte sheet. All the aforementioned preparation processes were conducted under the protection of an argon atmosphere.

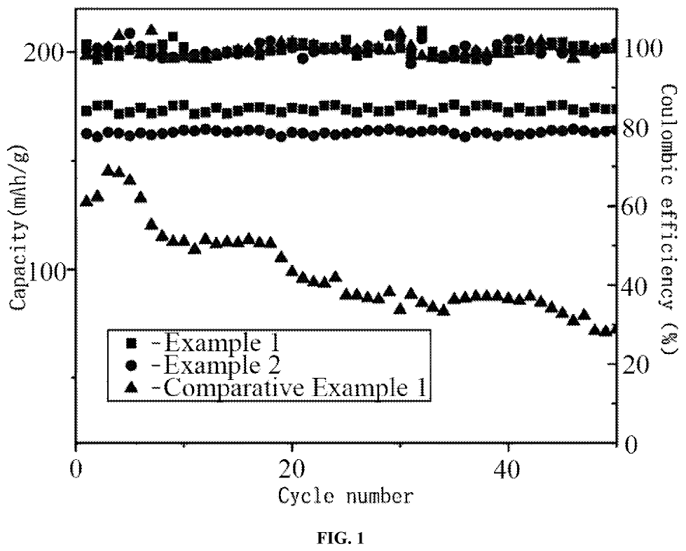

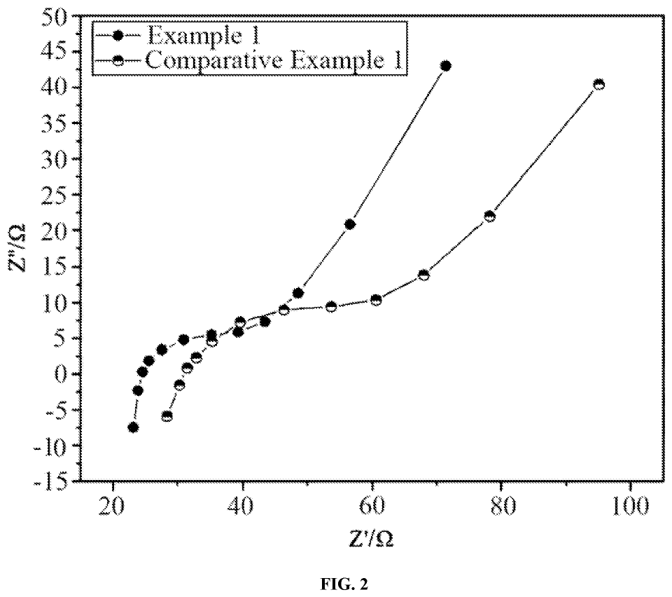

The solid electrolyte sheet has a lithium conductivity of 5×10⁻³ S/cm at room temperature. (The alternating-current (AC) impedance of the sulfide electrolyte was determined by using a multi-channel electrochemical workstation at a temperature of 298 K to 375 K and a frequency of 1 MHz to 10 Hz). The cycle efficiency is shown in FIG. 1. As shown in FIG. 1, the full cell has an excellent stability during 50 cycles. The impedance is shown in FIG. 2. As shown in FIG. 2, the solid electrolyte sheet prepared in Example 1 has a high ionic conductivity.

### EXAMPLE 2

This example provided a Li₆P_{0.8}Ta_{0.2}S₅F solid electrolyte, which was prepared as follows:

The reagents Li₂S, P₂S₅, and TaF₅ were weighed at a stoichiometric ratio of Li₂S:P₂S₅:VF₅=3:0.4:0.2, then mixed and manually ground for 15 min to obtain a mixture. The mixture was put into a zirconia ball mill jar, and zirconia balls were added thereto at a mass ratio of 1:50. After that, the mixture was subjected to ball milling at a speed of 550 rpm for 17 h; a resulting milled sample attached to the wall of the zirconia ball mill jar was scraped off, then ground manually with a mortar for 15 min, and then sieved through a 400-mesh sieve to obtain a uniformly mixed precursor. The precursor was pressed into a solid sheet (with a diameter of 12 mm) at 350 MPa. The solid sheet was packed into a quartz tube and sealed. The solid sheet was heated to a temperature of 550° C. at a heating rate of 0.5° C./min and held at the temperature for 7 h, and then cooled to obtain the Li₆P_{0.8}Ta_{0.2}S₅F solid electrolyte powder. It can be found from an X-ray diffraction (XRD) that the solid electrolyte powder prepared by this method is in an argyrodite-type cubic phase with desirable crystal form and high purity. The solid electrolyte powder was pressed at a pressure of 580 MPa for 3 min to obtain a solid electrolyte sheet. All the aforementioned preparation processes were completed under the protection of an argon atmosphere. The solid electrolyte sheet has a lithium conductivity of 5.3×10⁻³ S/cm at room temperature. (The AC impedance of the sulfide electrolyte was determined by using a multi-channel electrochemical workstation at a temperature of 298 K to 375 K and a frequency of 1 MHz to 10 Hz).

### COMPARATIVE EXAMPLE 1

This example provided a Li₆PS₅F solid electrolyte, which was prepared as follows:

The reagents Li₂S, P₂S₅, and LiF were weighted at a required stoichiometric ratio then mixed and manually ground for 15 min to obtain a mixture. The mixture was put into a zirconia ball mill jar, and zirconia balls were added thereto at a mass ratio of 1:50. After that, the mixture was subjected to ball milling at a speed of 550 rpm for 17 h; a resulting milled sample attached to the wall of the zirconia ball mill jar was scraped off, then ground manually with a mortar for 15 min, and then sieved through a 400-mesh sieve to obtain a uniformly mixed precursor. The precursor was pressed into a solid sheet (with a diameter of 12 mm) at 350 MPa. The solid sheet was packed into a quartz tube and sealed. The solid sheet was heated to a temperature of 550° C. at a heating rate of 0.5° C./min and held at the temperature for 7 h, and then cooled to obtain the Li₆PS₅F solid electrolyte powder. The solid electrolyte powder was pressed at a pressure of 580 MPa for 3 min to obtain a solid electrolyte sheet. All the aforementioned preparation processes were completed under the protection of an argon atmosphere. The solid electrolyte sheet in Comparative Example 1 has a lithium conductivity of 1.5×10⁻³ S/cm at room temperature.

### COMPARATIVE EXAMPLE 2

A Li₆P_{0.8}Sb_{0.2}S₅F sulfide solid electrolyte was provided, and the method for preparing the same was conducted similar to Example 1, except that in Comparative Example 2, the raw materials were Li₂S:P₂S₅:SbF₅=3:0.4:0.2.

The solid electrolyte sheet in Comparative Example 2 has a lithium conductivity of 1.1×10⁻³ S/cm at room temperature.

The specific embodiments of the present disclosure are described above. It should be understood that the present disclosure is not limited to the above specific embodiments, and a person skilled in the art could make various variations or modifications within the scope of the claims without affecting the essence of the present disclosure.

1. A sulfide solid electrolyte, having a chemical composition formula of Li₆P₁₋ₐ(M)ₐS₅X, wherein M is one or more selected from the group consisting of V, Nb, and Ta, and X is one or more selected from the group consisting of F, Cl, and Br.

2. The sulfide solid electrolyte according to claim 1, wherein a is in a range of greater than 0 and less than 1.

3. The sulfide solid electrolyte according to claim 2, wherein the a is in a range of greater than 0 and less than or equal to 0.2.

4. A method for preparing the sulfide solid electrolyte according to claim 1, comprising the following steps:
S1, weighing raw materials of a Li source, a P source, an S source, an M source, and an X source according to a stoichiometric ratio of the Li₆P₁₋ₐ(M)ₐS₅X, and then mixing to be uniform to obtain a mixture, and subjecting the mixture to ball milling to obtain a precursor powder of the sulfide solid electrolyte, a being in a range of greater than 0 and less than 1;
S2, sieving the precursor powder to obtain a sieved powder, and then pressing the sieved powder into a solid sheet; and
S3, subjecting the solid sheet to vacuum high-temperature sintering to obtain the sulfide solid electrolyte.

5. The method according to claim 4, wherein the raw materials in step S1 comprise the following components:
the Li source, being one or more selected from the group consisting of LiH, Li₂S₂, and Li₂S;
the S source, being one or more selected from the group consisting of S, H₂S, P₂S₅, P₄S₉, P₄S₃, Li₂S₂, and Li₂S;
the P source, being one or more selected from the group consisting of P, P₂S₅, P₄S₉, P₄S₃, P₄S₆, and P₄S₅;
the X source, being one or more selected from the group consisting of LiCl, LiBr, LiI, LiF, VCl₅, NbCl₅, and TaCl₅; and
the M source, being one or more selected from the group consisting of VF₅, NbCl₅, and TaCl₅.

6. The method according to claim 4, wherein the ball milling in step S1 is conducted at a speed of 380 rpm to 1,500 rpm for 7 h to 48 h.

7. The method according to claim 4, further comprising, in step S1, conducting manual grinding for 15 min to 30 min by using an agate mortar before the ball milling.

8. The method according to claim 4, wherein the ball milling in step S1 is conducted by using a planetary ball mill.

9. The method according to claim 4, wherein the sieving in step S2 is conducted by using a sieve of 300 mesh to 1,200 mesh.

10. The method according to claim 4, wherein the pressing in step S2 is conducted at a pressure of 300 MPa to 500 MPa.

11. The method according to claim 4, wherein the solid sheet in step S2 has a thickness of 200 μm to 1,000 μm.

12. The method according to claim 4, wherein the vacuum high-temperature sintering in step S3 is conducted at a temperature of 350° C. to 700° C. for 1 h to 8 h.

13. The method according to claim 4, wherein step S3 is performed by sealing the solid sheet in a vacuum quartz tube, then placing into a muffle furnace, and conducting high-temperature sintering to obtain the sulfide solid electrolyte.

14. The method according to claim 12, wherein the vacuum high-temperature sintering is conducted at a heating rate of 0.5° C./min to 5° C./min.

15. The method according to claim 4, further comprising, in step S3, cooling to room temperature at a rate of 0.5° C./min to 5° C./min after the vacuum high-temperature sintering is completed.

16. The method according to claim 4, wherein the weighing, the mixing to be uniform, the ball milling, the sieving, the pressing, and the vacuum high-temperature sintering in steps S1 to S3 each are conducted under the protection of an inert atmosphere.

17. (canceled)

18. A solid-state battery, comprising a cathode part, an anode part, and an electrolyte part; wherein at least one of the cathode part, the anode part, and the electrolyte part comprises the sulfide solid electrolyte according to claim 1.

19. The solid-state battery according to claim 18, wherein a weight of the sulfide solid electrolyte in the cathode part accounts for 0 wt % to 40 wt % of a total weight of the cathode part.

20. The solid-state battery according to claim 18, wherein a cathode active material in the cathode part is one or a mixture of two or more selected from the group consisting of LiCoO₂, LiFePO₄, LiNiₓCo_{y}Mn_{1-x-y}O₂, LiNiₓCo_{y}Al_{1-x-y}O₂, LiNi_{0.5}Mn_{1.5}O₄, and LiFeₓMn₁₋ₓPO₄.

21. The solid-state battery according to claim 18, wherein the anode part is constructed by mixing an anode active material and a sulfide solid electrolyte, and the anode active material is a lithium alloy anode material, and the sulfide solid electrolyte has a chemical composition formula of Li₆P₁₋ₐ(M)ₐS₅X, M being one or more selected from the group consisting of V, Nb, and Ta, and X being one or more selected from the group consisting of F, Cl, and Br.
